(19) United States
(12) Patent Application Publication
(10) Pub. No.: US 2012/0275152 A1
(43) Pub. Date: Nov. 1, 2012

(54) HEAT SINK FOR LIGHT MODULES

(75) Inventor: David George Payne, Beaverton, OR (US)

(73) Assignee: PHOSEON TECHNOLOGY, INC., Hillsboro, OR (US)

(21) Appl. No.: 13/454,479

(22) Filed: Apr. 24, 2012

Related U.S. Application Data
(60) Provisional application No. 61/480,604, filed on Apr. 29, 2011.
(60) Provisional application No. 61/533,695, filed on Sep. 12, 2011.

(51) Int. Cl. F21V 29/00

(52) U.S. Cl. 362/249.01

(57) ABSTRACT

A lighting fixture has a housing, a lighting module in the housing, the lighting module having a first surface containing an array of lighting elements, and a heat sink having fins, the heat sink attached to a second surface of the lighting module opposite to the first surface, the heat sink having a fin density of less than 0.25 fins per millimeter. A lighting fixture has a housing, a lighting module in the housing, the lighting module having a first surface containing an array of lighting element arranged in an array of elements along a horizontal axis and a vertical axis, and a heat sink attached to a second surface of the lighting module opposite the first surface, the heat sink having fins oriented to extend away from the heat sink along the vertical axis.

### RELATED APPLICATIONS

This application claims priority to U.S. Provisional Patent Applications 61/480,604, filed Apr. 29, 2011, and 61/533,695, filed Sep. 12, 2011.

### BACKGROUND

Solid-state light emitter arrays have become more prevalent in industrial lighting applications, replacing traditional lighting fixtures such as mercury arc lamps. Generally, solid-state light emitter arrays use less power, operate at cooler temperatures, and typically have fewer issues with disposal.

While the solid-state light emitter arrays typically do consume less power and operate at cooler temperatures, management of heat still raises issues with efficient operation of the light module. Solid-state light emitters, such as light emitting diodes (LEDs), may suffer from performance degradation unless the heat generated by the operation of the device is managed somehow.

One method of managing heat involves the use of a heat sink, typically a piece of thermally conductive material like metal attached to the backside of the array of emitters. The heat sink has a surface area that assists with the dissipation of heat. As the emitters generate heat during operation, the heat sink conducts the heat away from the array of transmitters to a cooling structure.

Cooling structures typically involve air or water cooling structures that draw the heat away from the heat sink and allow the heat sink to continue to conduct heat. Current heat sinks can typically handle heat management for lighting modules at lower irradiance powers, such as 4 W/cm². However, users desire higher power lighting modules, sometimes in smaller packages, reducing the available surface area of the heat sink for thermal conductivity.

### BRIEF DESCRIPTION OF THE DRAWINGS

FIG. 1 shows a prior art embodiment of a heat sink next to an embodiment of a heat sink in accordance with the embodiments of the invention.

FIG. 2 shows a composite of embodiments of different lighting modules with their corresponding heat sinks.

FIG. 3 shows an embodiment of a thicker base heat sink.

FIG. 4 shows an embodiment of a thicker base heat sink and external baffles.

FIG. 5 shows an embodiment of a thicker base heat sink with thick fins.

FIG. 6 shows an embodiment of a heat sink having vertical fins.

FIGS. 7-9 show embodiments of lighting modules having vertical fins.

### DETAILED DESCRIPTION OF THE EMBODIMENTS

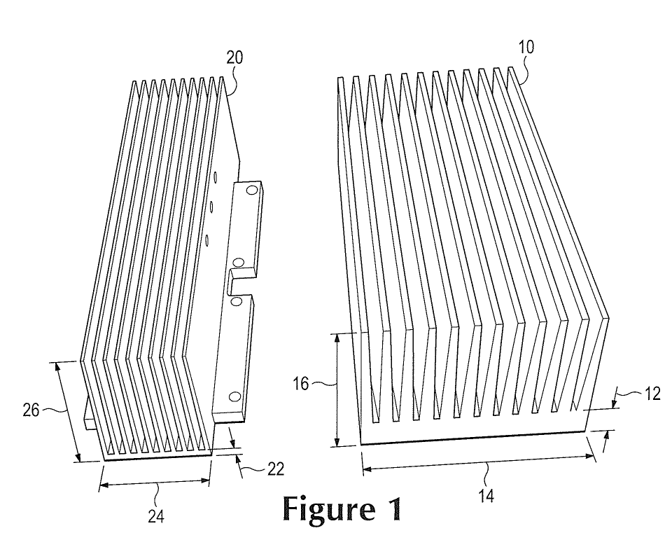

FIG. 1 shows an embodiment of a heat sink having a thicker base, longer and thicker fins, with fewer fins per square inch. The thicker base dissipates more heat by reducing thermal resistance. Further, in previous heat sinks, significant thermal resistance existed at the connection between the heat sink base and fins. The thicker base and thicker fins alleviates some of that resistance.

Experiments show that using fewer, thicker fins dissipates more heat than the smaller, thinner fins. The fins taper away from the base, as thermal resistance away from the base becomes less critical. This also allows for better air flow through the fins.

Turning to FIG. 1, one can compare the prior art heat sink and the embodiment of the heat sink having the thicker base. The following measures are merely for discussion and not intended to limit application of the embodiments of the invention to any particular set of measurements. The prior art heat sink 20, for example, has a base with a thickness dimension 22 of about 5 millimeters (mm). The width 24 of the heat sink is 24 mm, and the fins have a height 26 of 33 mm.

The thicker base heat sink in accordance with the embodiments of the invention 10 has a thickness dimension 12 of 8 mm, a width 14 of 55 mm, and the height 16 of 38 mm. As can also be seen, the prior art heat sink 20 has 12 fins over the 24 mm width. The current heat sink has 12 fins over the 55 mm width. As mentioned above, these are just examples for comparison purposes and are shown in the table below for comparison. In more general terms, the thicker base heat sink has a base of a thickness of at least 8 mm, a width of at least 50 mm and a height of at least 35 mm.

| | Current heat sinks | Thicker heat sink |
|---|---|---|
| Base thickness (mm) | 5 | 8 |
| Width (mm) | 24 | 55 |
| Fin height (mm) | 33 | 38 |
| Fin density (#/mm) | 0.5 | 0.22 |

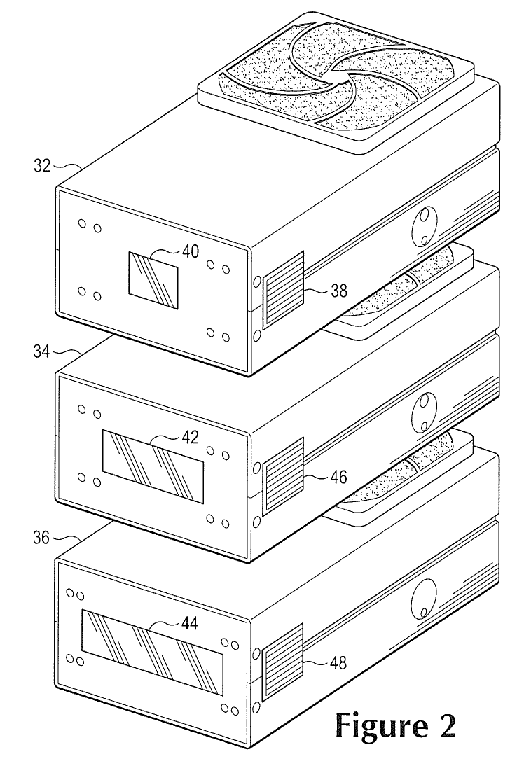

FIG. 2 shows a composite of embodiments of lighting modules having heat sinks with thicker bases. The different light modules have different powers based upon the size of the array. For example, fixture 32 has an array 40 that may be thought of being a single array. In this discussion, the term ‘module’ means an entire grouping of the lighting elements. An ‘array,’ in contrast, is a pre-defined set of lighting elements. A module may be some multiple of the number of arrays, or a larger array. The arrays and modules are housed in a housing to form a lighting fixture.

Fixture 34 has an array 42 that is either a larger single array or a set of multiple ones of the array 40. Similarly, fixture 36 has an array 44 that may consist of a larger array or multiple of the array 40. Each of these fixtures have heat sinks 38, 46 and 48 that have a thicker base similar to the one of FIG. 1.

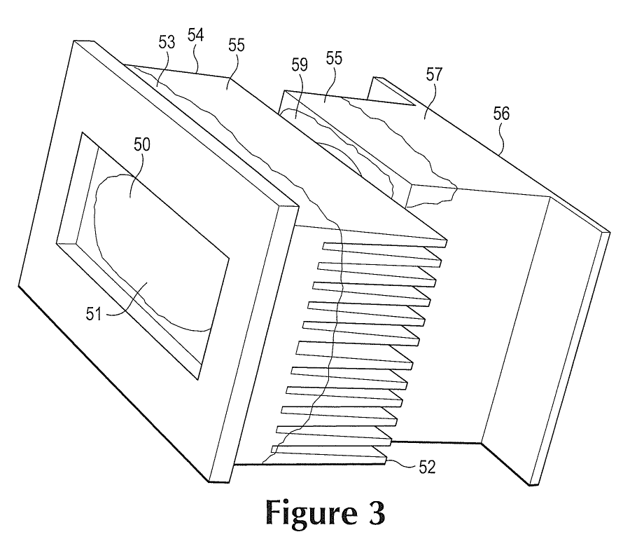

FIG. 3 shows a thermograph of a lighting module array 50 mounted to a heat sink 54, having a thicker base and fewer fins per millimeter, but where the fins are thicker and longer. The temperatures run from hottest to coldest, the regions shown by the lines. The hottest area is the module 50 in region 51. Next hottest is the front of the heat sink and the areas of the back and sides of the heat sink adjacent the front face in region 53. The next hottest is the tip of the fins in the heat sink, such as fin 52 and the region on the exterior of the fan 55. The coolest of the structures shown is the fan 56 in regions 57 and 59.

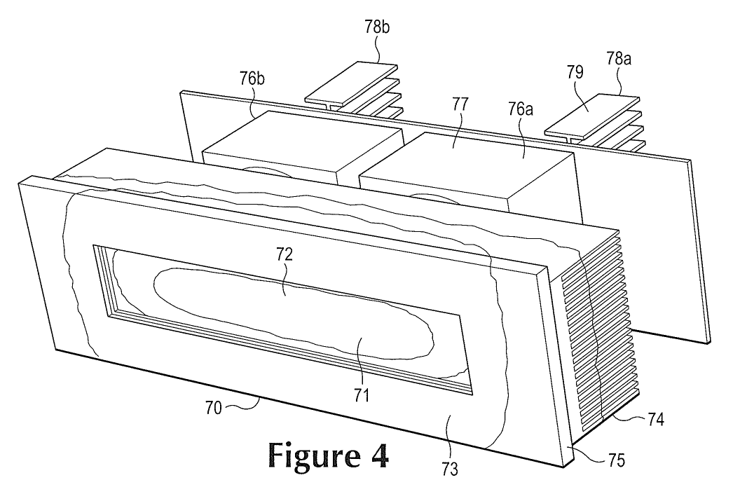

FIG. 4 shows an alternative light module having an array 72 with a much larger horizontal extent. This lighting module has two fans 76a and 76b, but only one heat sink 74 having the thicker base and fewer, but thicker and longer, fins. In addition, this module has external baffles 78a and 78b. The baffles assist in directing the air away from the lighting fixture. The hottest area is the region 71, followed by region 73, then 75. The region 77 just adjacent to the fans 76a and 76b is coolest, and the region of the baffles 79 has similar heat profiles to the region 75.

Certain industrial lighting applications involve curing of inks and coatings on thin substrates, such as paper or film. The output of the fans may disrupt the smooth movement of the thin substrates or cause uncured inks or coatings to move or smear. Use of external baffles such as 78a and 78b may alleviate this problem.

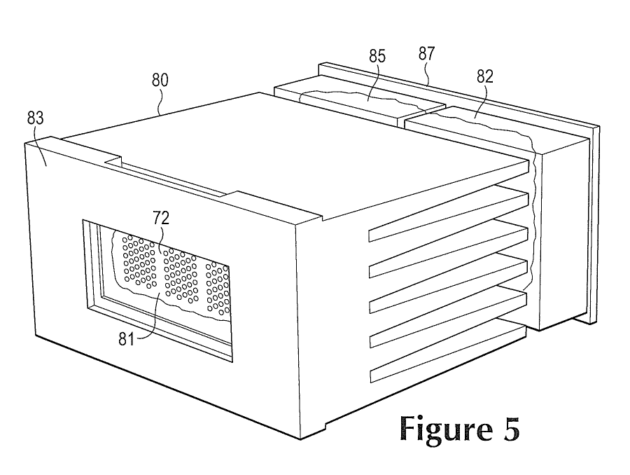

FIG. 5 shows an analysis of one of the smaller arrays 72, such as the array 40 of FIG. 2. The regions have similar temperature comparisons to the other figures. The hottest region is 81, followed by 83. The region 87 is next coolest, with the coolest region 85 being directly adjacent to the fans.

The heat sink shown here has only 6 fins, whereas most of the others have 12. It is possible, for ease of manufacturing, to manufacture the heat sinks with a higher number of fins and a larger separation between the middle two fins. This allows them to be divided into smaller heat sinks such as the one shown in FIG. 5. The manufacturing may involve heat sinks having a number of fins that are a multiple of a smaller number, with wider gaps after each multiple. The heat sink 80 is cooled by fan 82.

Managing the flow of air between the fins of the heat sink and the fan has a large impact on the ability to manage heat. Typically, the fins on a heat sink extend out from the heat sink along the horizontal axis, as shown in FIG. 5. The fins then ‘stack’ from top to bottom.

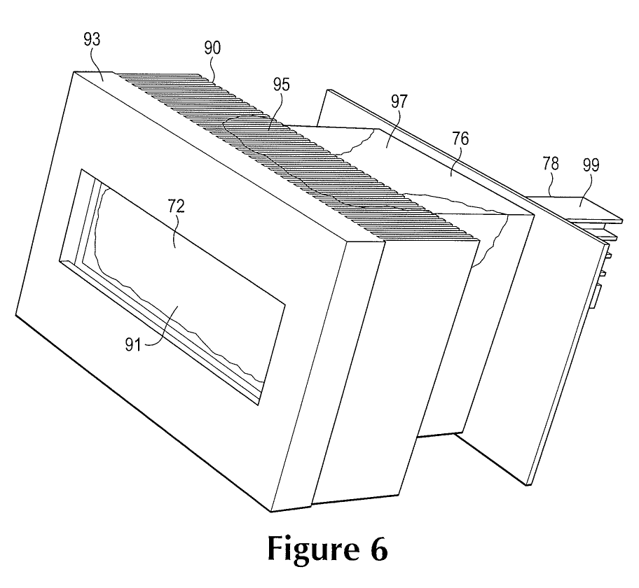

However, experiments have shown that turning the fins such that they extend out from the heat sink along the vertical direction, as shown in FIG. 6, raises the efficiency of the air flow. In the embodiment of FIG. 6, the fins are stacked left to right and oriented in the vertical direction. This results in more efficient air flow and higher efficiency cooling. For purposes of discussion, the orientation will be referred to as horizontal if they extend out from the heat sink along the long axis of lighting module as in FIG. 5, and vertical if they extend along the short axis of the lighting module as in FIG. 6.

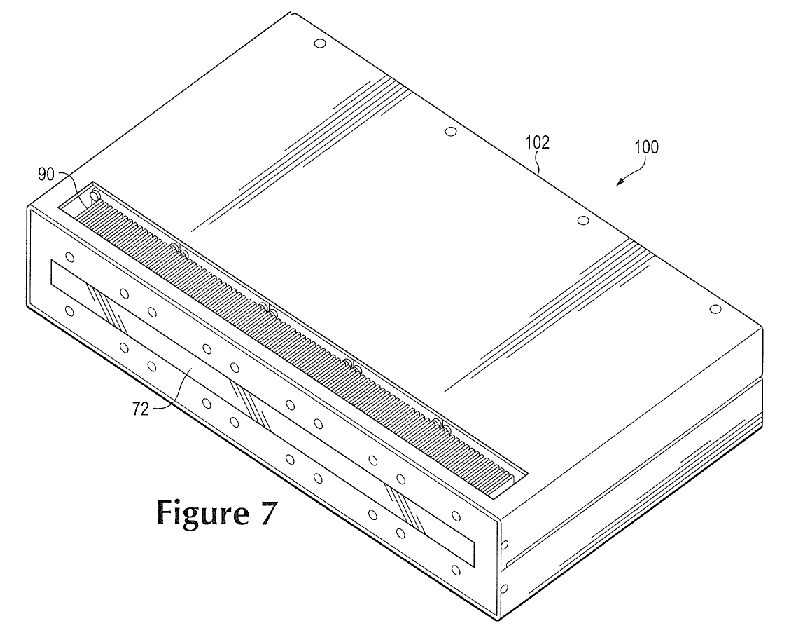

FIGS. 7-9 show more detailed views of embodiments of lighting fixtures having heat sinks with vertical fins. FIG. 7 shows a top perspective view of a lighting fixture 100 having heat sinks with vertical fins 90. The array or arrays of light emitting elements 72 are thermally coupled to the heat sinks with vertical fins. The top of the housing 102 has an opening to allow the air to circulate away from the heat sink fins. This prevents the air from disturbing the print surface that would be opposite the light module, where the curable ink is on the print surface.

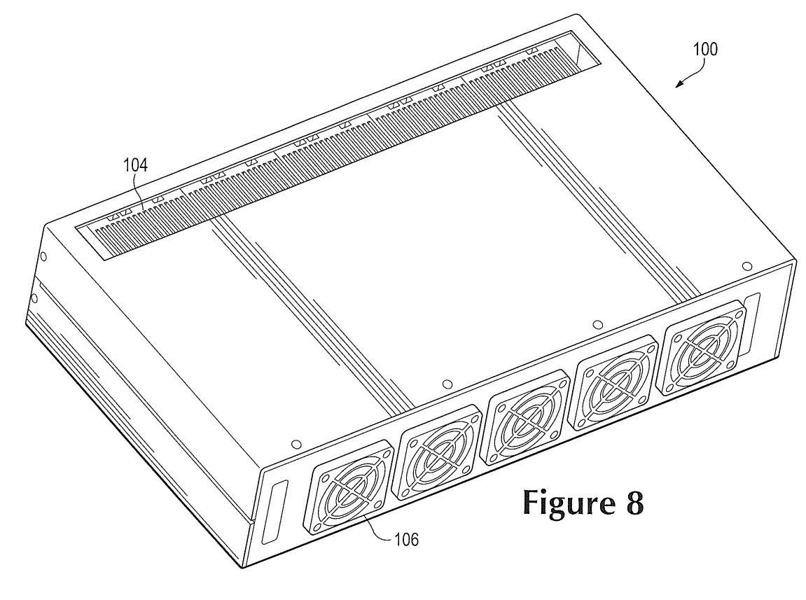

FIG. 8 shows a top perspective rear view of a lighting fixture. The lighting module in this embodiment has a bank of heat sinks, such as 104, but may instead include one large heat sinks, two smaller heat sinks, etc. Similarly, the lighting fixture has a number of fans such as 106 that correspond to the number of heat sinks. However, there could be more or fewer fans than heat sinks, depending upon factors such as power consumption, cooler, surface area, etc.

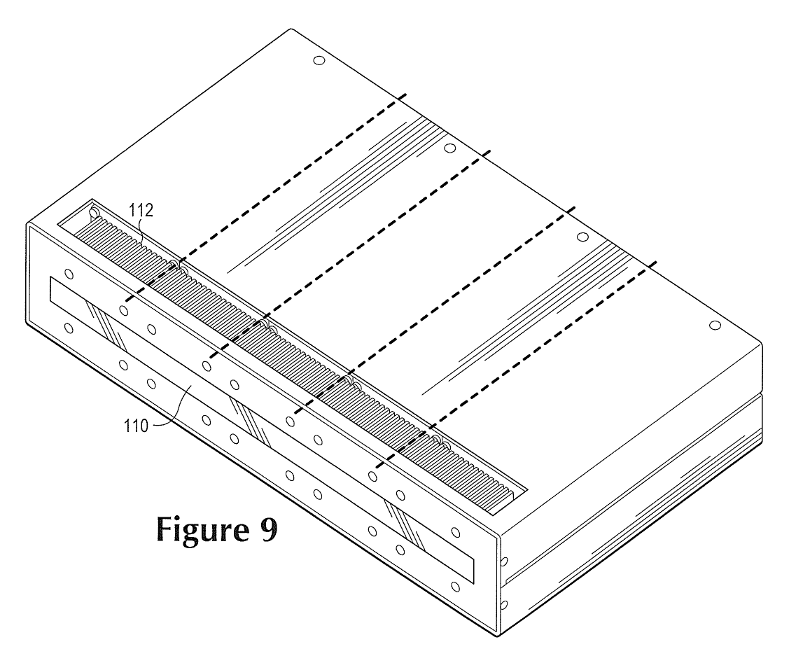

One advantage of having the number of heat sinks correspond to the number of fans is that the heat sink layout becomes modular. FIG. 9 shows such an example. The dashed lines indicate the division of the lighting array 72 from FIG. 6 into individual arrays of lighting elements such as array 110, the division of the heat sink into individual, smaller, heat sinks such as 112, and correspond to the separation between the fans. This allows a user to modularize the size of the lighting fixture, including the array of light emitting elements and their associated cooling systems.

There has been described to this point a particular embodiment for an improved heat sink, with the understanding that the examples given above are merely for purposes of discussion and not intended to limit the scope of the embodiments and claims to any particular implementation.

What is claimed is:

1. A lighting fixture, comprising:
a housing;
a lighting module in the housing, the lighting module having a first surface containing an array of lighting elements; and
a heat sink having fins, the heat sink attached to a second surface of the lighting module opposite to the first surface, the heat sink having a fin density of less than 0.25 fins per millimeter.

2. The lighting fixture of claim 1, wherein the heat sink further comprises a heat sink having a base with a thickness of at least 8 millimeters

3. The lighting fixture of claim 1, wherein the heat sink further comprises a heat sink having a width of at least 50 millimeters.

4. The lighting fixture of claim 1, wherein the heat sink further comprises a heat sink having a fin height of at least 35 millimeters.

5. The lighting fixture of claim 1, wherein heat sink has a number of fins equal to a multiple of a smaller number, where the heat sink has a slightly larger gap between fins at each multiple.

6. The lighting fixture of claim 1, further comprising at least one fan.

7. The lighting fixture of claim 1, wherein the lighting module comprises a number of arrays.

8. The lighting fixture of claim 7, wherein the lighting module comprises a number of fans corresponding to the number of arrays.

9. The lighting fixture of claim 1, further comprising at least one baffle arranged adjacent the heat sink.

10. A lighting fixture, comprising:
a housing;
a lighting module in the housing, the lighting module having a first surface containing an array of lighting element arranged in an array of elements along a horizontal axis and a vertical axis; and
a heat sink attached to a second surface of the lighting module opposite the first surface, the heat sink having fins oriented to extend away from the heat sink along the vertical axis.

11. The lighting fixture of claim 10, further comprising at least one fan.

12. The lighting fixture of claim 10, further comprising a baffle adjacent the heat sink.

13. The lighting fixture of claim 10, wherein the lighting module comprises a number of arrays.

14. The lighting of fixture of claim 13, further comprising at least one fan, wherein a number of fans corresponds to the number of arrays.
